(19) United States
(12) Patent Application Publication
(10) Pub. No.: US 2006/0271699 A1
(43) Pub. Date: Nov. 30, 2006

(54) Method and apparatus for providing content services on an audio/video (A/V) network supporting web service technique

(75) Inventors: Ye-youl Lee, Seoul (KR); Yoo-seung Hwang, Seoul (KR); Giu-yeol Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/417,199

(22) Filed: May 4, 2006

(30) Foreign Application Priority Data
May 11, 2005 (KR) 2005-39414

(51) Int. Cl. G06F 15/16

(52) U.S. Cl. 709/230

(57) ABSTRACT

A method and apparatus are disclosed for providing content services in an A/V network supporting web service techniques. An A/V gateway includes a content information requesting unit which requests information about contents to be provided by web services on a distributed network when a predetermined condition is satisfied; a TCP/IP transceiver which receives an ML document including the information about the contents as a response to the request from a service providing device providing the web services; a web service content managing unit which analyzes the ML document including the information about the contents, and generates a reconstructed ML document on the basis of the analysis result; a SOAP server transceiver which transmits the reconstructed ML document; and an A/V network transceiver which transmits a content stream corresponding to the information about the contents.

### CROSS-REFERENCE TO RELATED APPLICATIONS

This application claims all benefits accruing under 35 U.S.C. §119 from Korean Patent Application No. 10-2005-0039414 filed on May 11, 2005 in the Korean Intellectual Property Office, the disclosure of which is incorporated by reference herein.

### BACKGROUND OF THE INVENTION

1. Field of the Invention

The present invention relates to a method and apparatus for providing a content service in an audio/video (A/V) network. In particular, the present invention relates to a method and apparatus which can use web services in an A/V device using an A/V gateway for providing the web services.

2. Related Art

In recent years, with the development of digital audio/video (hereinafter, referred to as “A/V”) processing techniques, various A/V devices, such as digital televisions, set-top boxes, digital versatile disk (DVD) players, and digital amplifiers, are installed and used in a home or an office. A user can conveniently control these A/V devices using a remote control device or the like. However, as the number of A/V devices to be installed in a predetermined space is increased, the control of the individual A/V devices becomes more and more complex and difficult.

Accordingly, techniques have been studied to connect a plurality of A/V devices to one another for systematization so as to allow the user to conveniently control the systematized A/V devices. According to these studies, A/V devices are connected to other A/V devices, via a network interface, to construct a single A/V network system as a whole.

As a part of these studies, an eXpandible Home Theater (XHT) technique specification, which is middleware for A/V home networking, is recently developed and suggested. The XHT technique is a digital TV-oriented home network solution which has been developed by Samsung Electronics Co., Ltd. Such a XHT technique has been adopted as an industry standard by the Consumer Electronics Association (CEA).

The XHT technique controls multiple digital TVs as well as A/V devices connected to the digital TVs by way of IEEE 1394 cables, which can stably transfer a plurality of HD (high definition) signals and Internet protocols which are the standard widely used in Internet. With the XHT technique, a user can watch a digital broadcast in the bed room, for example, using the function of receiving the digital broadcast of the digital TV in the living room.

In addition, an inexpensive network interface unit (NIU) has been developed on the basis of the XHT technique, in the form of a memory card. Such a network interface unit (NIU) can be easily changed according to the type of broadcasting signals, such as, for example, ground waves, satellites, cables, which results in the reduction in economical burden of broadcast industrialists. In particular, the XHT technique enables various kinds of portal services through the built-in browser of the digital TV.

The operation sequences of the A/V devices implemented using the XHT technique will be described as follows. First, local IP addresses are individually allocated to the A/V devices in the XHT network by a predetermined address allocation algorithm. Next, the individual A/V devices with the local IP addresses allocated thereto express device information by an XML (eXtensible Markup Language) file (DeviceInfo.xml) according to the defined syntactic format (defined by a file called DeviceInfo.xsd) and transmits the XML file to other A/V devices. The file called DeviceInfo.xml records a URI (Uniform Resource Identifier) of a file (XHT931.xsd) which describes a set of HTTP (HyperText Transfer Protocol) commands for operating the A/V device. The A/V device which generates the file called DeviceInfo.xml refers to the file called XHT931.xsd, generates an XML file (XHT931.xml) which records the HTTP command supported by the corresponding device, and transmits the XML file to other A/V devices.

An A/V device receives a DeviceInfo.xml file expressing the device information of another A/V device, and an XML file (XHT931.xml) recording the HTTP commands to be supported by another A/V device. Then, the A/V device grasps the information of another A/V device which transmits the files on the basis of the received files so as to control another A/V device using the HTTP commands.

FIG. 1 shows an example detail of a file called DeviceInfo.xml generated in each A/V device according to the grammar structure (syntax) of DeviceInfo.xsd. Such a file 10 includes a deviceInfo tag 12, a manufacturer tag 13, a functionType tag 14, a 1394StreamSource tag 15, a userInterface tag 16, an eventNotificationUI tag 17, and a HTTPCommandInterfaceRef tag 18.

The deviceInfo tag 12 includes positional information, date, and version of the file called deviceInfo.xsd. The manufacturer tag 13 includes the manufacturer name, URI, and manufacturing date of the A/V device. The functionType tag 14 includes the functional name, sub-name, and model name of the product. The 1394StreamSource tag 15 includes the coding system and bit rate of the stream.

In addition, the userInterface tag 16 includes information about a user interface. The eventNotificationUI tag 17 includes information about a user interface which notifies of occurrence of events. In the example shown in FIG. 1, the functions about the user interfaces are not supported. Also, an HTTPCommandInterfaceRef tag 18 includes the name of the XHT specification supporting the HTTP commands and the URI defining the commands (XHT931.xsd).

FIG. 2 shows an example detail of a file called XHT931.xml generated in each A/V device according to the grammar structure (syntax) of XHT931.xsd. Such a file 20 includes an OperationList tag 22, and a plurality of operation codes 23, 24, 25, 26, 27 and 28 to provide different types of functions of the A/V device.

The OperationList tag 22 includes the URI, date, and version of the file called XHT931.xsd to be referred to. Next, operation codes which are supported by the corresponding A/V device are recorded. In the example shown in FIG. 2, the A/V device supports a function 23 of notifying other A/V devices of the occurrence of a change in device status (EVENT-NOTIFICATION), a function 24 of turning on or off the power supply (POWER), a function 25 of playing an assigned contents (PLAY), a function 26 of stopping the play of the contents under play (STOP), a function 27 of pausing the contents under play (PAUSE), and a function 28 of rewinding the contents (REWIND).

If a first A/V device, which receives DeviceInfo.xml and XHT931.xml, wants to control a second A/V device which transmits the XML files, the first A/V device can control the second A/V device by way of the HTTP commands which are the combinations of the URI and the operation codes.

For example, when the first A/V device is a digital TV and the second A/V device is a source device which stores a transport stream (TS), the user issues a watch command of a program included in the transport stream (TS) to the digital TV using a remote control device. If an IP address allocated to the source device is 192.168.0.2, the digital TV (i.e., the first A/V device) just transfers the HTTP command of “http://192.168.0.2./CEA931?play&press” to the source device (i.e., the second A/V device). The A/V device according to the XHT specification has a web server, and a device controller which converts the above-described HTTP command into a device operation built-in. Accordingly, the source device can perform the corresponding operation according to the transferred HTTP command. Therefore, the source device transmits the transport stream (TS) to the digital TV using the IEEE 1394 network, and the digital TV decodes the received transport stream (TS) and displays the decoding result for the user.

In case of a simple web site, the movement to the corresponding web site is easily performed through links provided on a graphical user interface (GUI) screen of the A/V device. However, only with the conventional A/V network standards, various contents on the web and Ethernet cannot be provided through the direct connection to the A/V devices, such as the XHT digital TVs. In particular, the XHT is so configured to transmit the MPEG-2 transport stream, which is content data, onto data link hierarchies of the IEEE 1394 network using an isochronous channel. Accordingly, content information such as text in forms of HTML of the existing web site can be directly processed, while various contents such as motion picture data and macro media flash contents cannot be provided.

Therefore, there is a need for a method which can provide various kinds of content data by applying SOAP-based web service techniques to the A/V network devices.

### SUMMARY OF THE INVENTION

Several aspects and example embodiments of the present invention provide a method and apparatus for providing contents services in an A/V network which can share various contents of devices connected to an A/V network device by an Ethernet-based IP network and contents on Internet.

Additional aspects and/or advantages of the invention will be set forth in part in the description which follows and, in part, will be obvious from the description, or may be learned by practice of the invention.

In accordance with an embodiment of the present invention, a control apparatus is provided on an audio/video (AV) network to search web services providing contents on a different network connected to the A/V network by an A/V gateway and to receive information about the contents from a device providing the web services, thereby controlling the web services using the information about the contents. Such a control apparatus comprises a web browser which receives a control command relative to the contents from a user; a simple object access protocol (SOAP) client transceiver which receives a content information message including the information about the contents depending on a SOAP specification; a web service message managing unit which generates a control command message including the control command depending on the SOAP specification, analyzes the contents information message, and extracts the information about the contents to be provided to the web browser; an A/V network transceiver which receives stream data of the contents; a content decoder which decodes stream data, and a content display unit which outputs decoded stream data.

According to an aspect of the present invention, the different network is a TCP/IP Ethernet-based network such as the Internet. The control apparatus depends on an extendible home theater (XHT) specification, and the A/V network is an IEEE 1394 network.

In accordance with another embodiment of the present invention, an A/V gateway which connects an A/V network to a different network, comprises a content information requesting unit which requests information about contents to be provided by web services on a distributed network when a predetermined condition is satisfied; a TCP/IP transceiver which receives an ML document including the information about the contents as a response to the request from a service providing device providing the web services; a web service content managing unit which analyzes the ML document including the information about the contents, and which generates a reconstructed ML document on the basis of the analysis result; a SOAP server transceiver which transmits the reconstructed ML document; and an A/V network transceiver which transmits a content stream corresponding to the information about the contents.

In accordance with yet another embodiment of the present invention, a method of providing content services using web services which provide contents on a different network connected to an A/V network by an A/V gateway, comprises requesting the A/V gateway for content information; receiving a content information page corresponding to the request of the content information; causing a user to select specified contents through the content information page and to input a control command relative to the specified contents; transmitting the control command; and receiving stream data of the contents depending on the control command.

In accordance with another embodiment of the present invention, a method of providing content services using web services which provide contents on a different network connected to an A/V network by an A/V gateway, comprises requesting content information to be provided by the web services on a distributed network when a predetermined condition is satisfied; receiving an ML document including the content information as a response to the request from a service providing device providing the web services; analyzing the ML document including the content information, and generating a reconstructed ML document on the basis of the analysis result; transmitting the reconstructed ML document; and transmitting a content stream corresponding to the content information.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a diagram showing an example detail of a file called DeviceInfo.xml generated in each A/V device according to the grammar structure of DeviceInfo.xsd;

FIG. 2 is a diagram showing an example detail of a file called XHT931.xml generated in each A/V device according to the grammar structure of XHT931.xsd;

FIG. 3 is a diagram showing a configuration of an entire system according to an embodiment of the present invention;

FIG. 4 is a block diagram showing a configuration of a control apparatus according to an embodiment of the present invention;

FIG. 5 is a block diagram showing a configuration of an audio/video gateway according to an embodiment of the present invention;

FIG. 6 is a diagram showing an example service search request message in a web service technique;

FIG. 7 is a diagram showing an example response message to a service search request message in a web service technique;

FIG. 8 is a drawing showing an example Web Services Description Language (WSDL) message including detailed information of a service;

FIG. 9 is a drawing showing an example detail of a file in which the grammar structure for converting the WSDL file shown in FIG. 8 into an extensible Markup Language (XML) file to be supported by the control apparatus shown in FIG. 4; and

FIG. 10 is a flow chart showing an overall operation of a method of providing a content service according to an embodiment of the present invention.

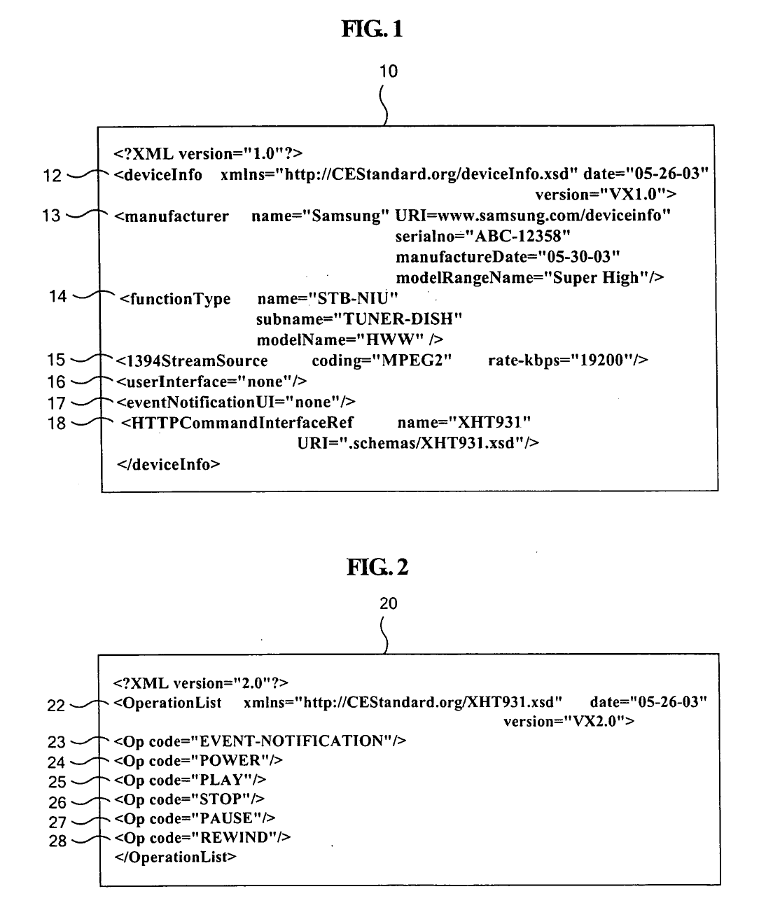

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

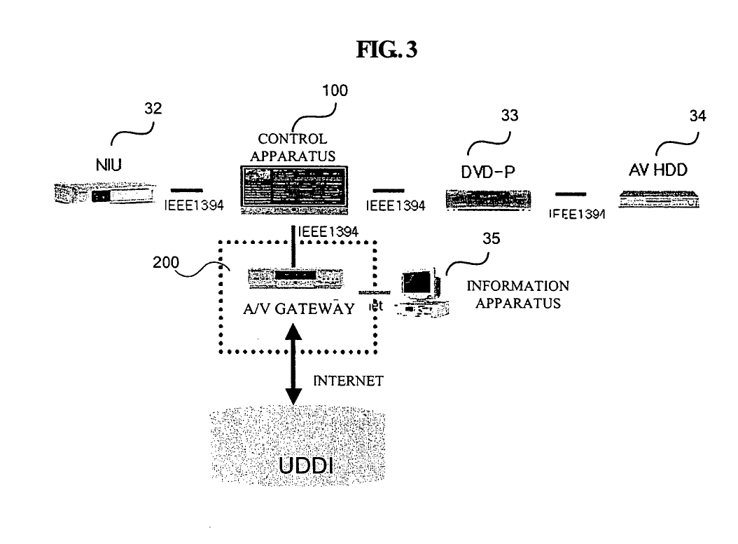

FIG. 3 is a diagram showing the configuration of an entire system according to an embodiment of the present invention.

An entire system according to the present invention includes a control apparatus 100, such as a digital TV, one or more A/V devices 32 to 34 which are connected to the control apparatus 100 by an A/V network, and an A/V gateway 200 which connects the control apparatus 100 to an Ethernet-based PC 35 or the Internet. The A/V devices 32, 33 and 34 can be a network interface unit (NIU), a DVD player (DVD-P) and a hard disk drive (HDD) with an IEEE 1394 interface, respectively.

According to an embodiment of the present invention, the control apparatus 100 includes at least a content decoder (not shown) which decodes the contents (multimedia data such as video, image, and sound), and a content display unit (not shown) which displays the decoded contents and outputs the display result to a user. The control apparatus 100 can request information about contents to be provided by web services and perform the control of the desired contents. The control apparatus 100 includes any one of digital TVs, PDPs, LCD monitors, and audio receivers.

The A/V gateway 200 connects the control apparatus 100 of the A/V network to a TCP/IP Ethernet-based network such as the Internet. The A/V gateway 200 receives information about the contents to be provided in forms of web services according to the request of the control apparatus 100, and provides a user interface (hereinafter, referred to as ‘UI’) including a contents list from that information to the control apparatus 100. The A/V gateway 200 may be implemented by a stand alone device having only the above-described functions in the A/V network or one module in the control apparatus 100.

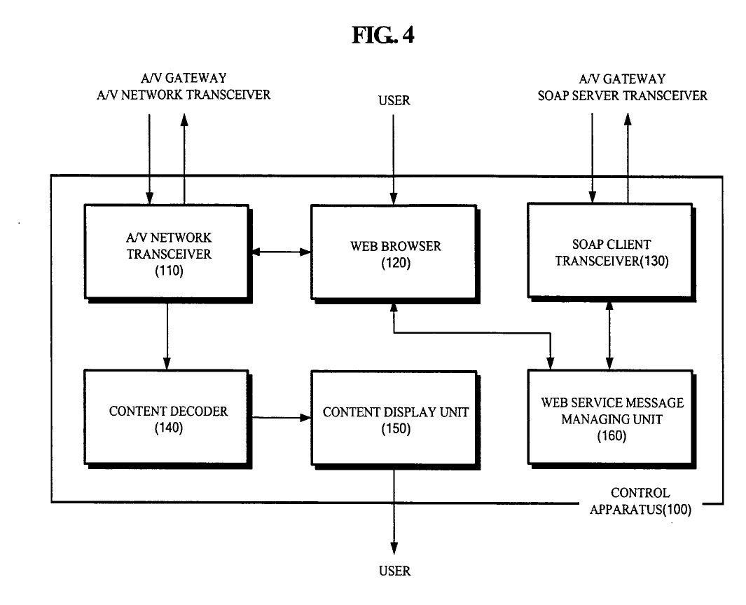

FIG. 4 is a block diagram showing the configuration of the control apparatus 100 according to an embodiment of the present invention. The control apparatus 100 according to the embodiment of the present invention includes an A/V network transceiver 110, a web browser 120, a SOAP client transceiver 130, a content decoder 140, a content display unit 150, and a web service message managing unit 160.

The control apparatus 100 receives the information about the desired contents and the control command relative to the contents from the user through the web browser 120. The web browser 120 provides the received user command to the web service message managing unit 160.

The web service message managing unit 160 generates a SOAP message including the user command received through the web browser 120, and transmits the generated SOAP message to the A/V gateway 200 through the SOAP client transceiver 130. Then, the web service message managing unit 160 analyzes the SOAP message received from the A/V gateway 200 by the SOAP client transceiver 130, and provides information to be displayed on the web browser 120.

The A/V network transceiver 110 receives a content stream from the A/V gateway 200 and provides the received content stream to the content decoder 140. When an IEEE 1394 network is used for the A/V network, an MPEG-2 transport stream, which is to be content data, is transmitted onto data link hierarchies of the IEEE 1394 network using an isochronous channel. At this time, the A/V network transceiver 110 takes charge of transmission and reception of contents data.

The SOAP client transceiver 130 transmits the SOAP message generated by the web service message managing unit 160 to the A/V gateway 200. Further, the SOAP client transceiver 130 receives texts or simple web pages in forms of HTML or XML, which are transmitted by a SOAP server transceiver 230 of the A/V gateway, using a simple object access protocol (SOAP) and control data of an A/V network specification, and provides received data to the web service message managing unit 160.

The content decoder 140 decodes the content stream to be provided from a service providing device 300 which possesses the contents selected by the user, and provides the decoding result to the contents display unit 150. The content stream may be a video stream of an MPEG-2 TS format or an audio stream of an MPEG Layer 3 (hereinafter, referred to as ‘MP3’) format. Besides, the streams of various video or audio formats can be used. However, when the content is an image, after downloading of a file of an image format such as JPEG is completed (not stream format), the content is decoded.

The content display unit 150 displays the contents decoded by the content decoder 140 for the user. When the content is a video or image format, the content is displayed using a display device, such as a cathode ray tube (CRT), an LCD, a PDP. When the content is an audio format, the content is displayed through an amplifier or speaker.

In the meantime, a control apparatus 100 according to another embodiment of the present invention may not include the SOAP client transceiver 130 and the web service message managing unit 160. In this case, the control apparatus 100 transmits various user commands depending on the A/V network specification to the A/V gateway 200 through the A/V network transceiver 110. Then, a web service contents managing unit 240 of the A/V gateway 200 converts the messages depending on the A/V network specification into messages depending on a SOAP specification.

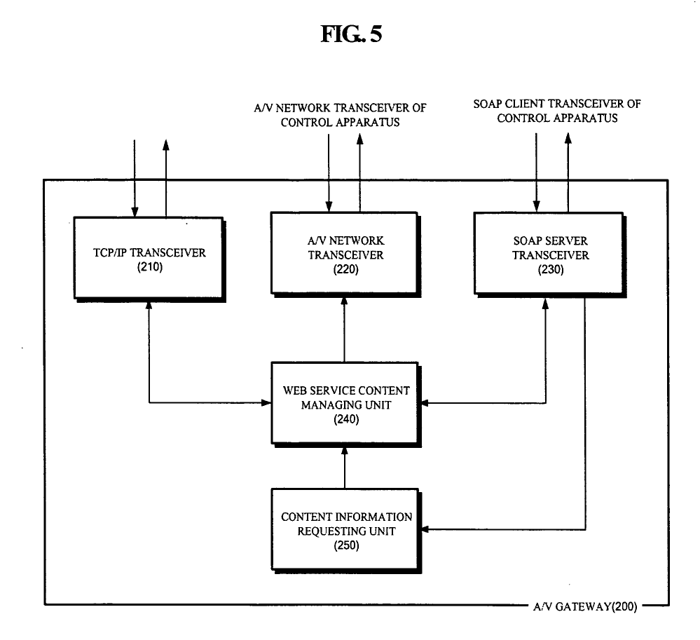

FIG. 5 is a block diagram showing the configuration of the A/V gateway according to an embodiment of the present invention. The A/V gateway 200 according to the embodiment of the present invention includes a TCP/IP transceiver 210, an A/V network transceiver 220, a SOAP server transceiver 230, a web service content managing unit 240, and a content information requesting unit 250.

The content information requesting unit 250 requests content information provided by web services on a distributed network through the web service content managing unit 240 when a predetermined condition is satisfied. For example, the content information requesting unit 250 can request the content information on the assumption that a content list request is received from the control apparatus 100. Alternatively, the content information requesting unit 250 can set a cycle for requesting the content information and request the content information for each cycle.

The content information can include meta data such as the title, kind (video, image, or audio), player (director or singer), generation date, encoding system, bit rate of the contents, the storage position of the contents (URI), and control operations (play, stop, or pause) to be supported by the contents.

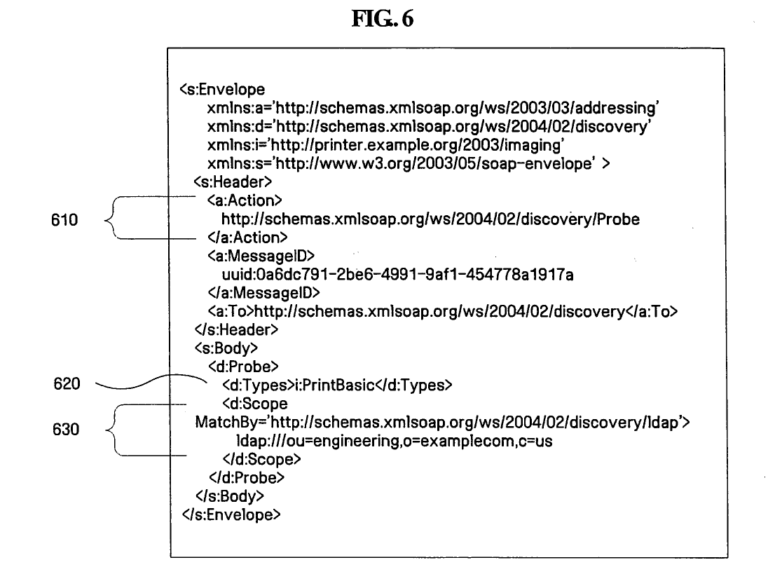

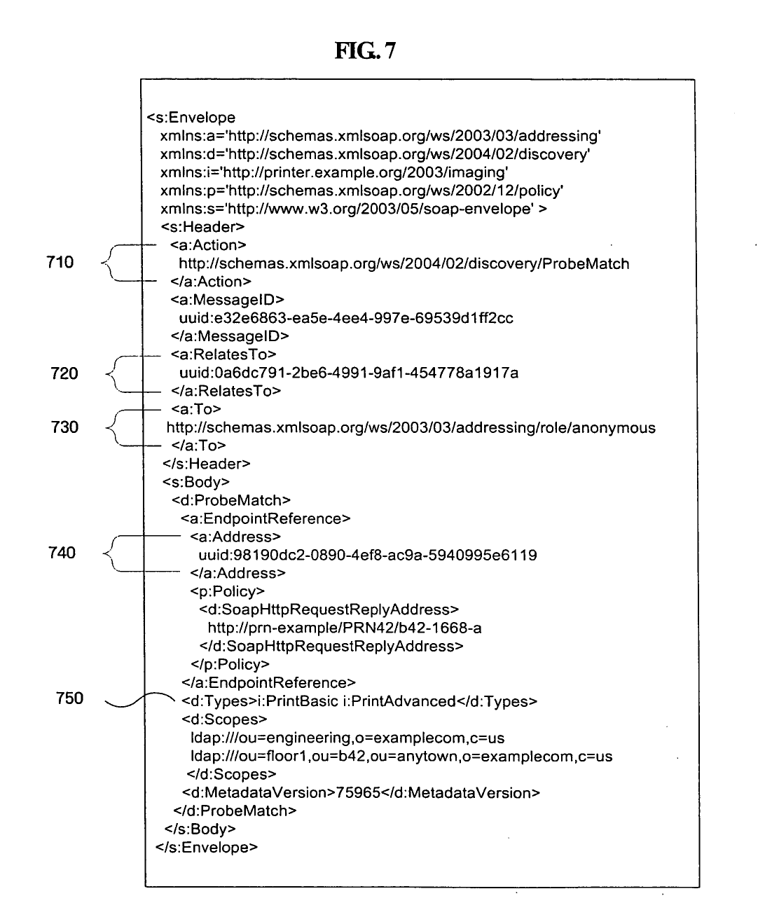

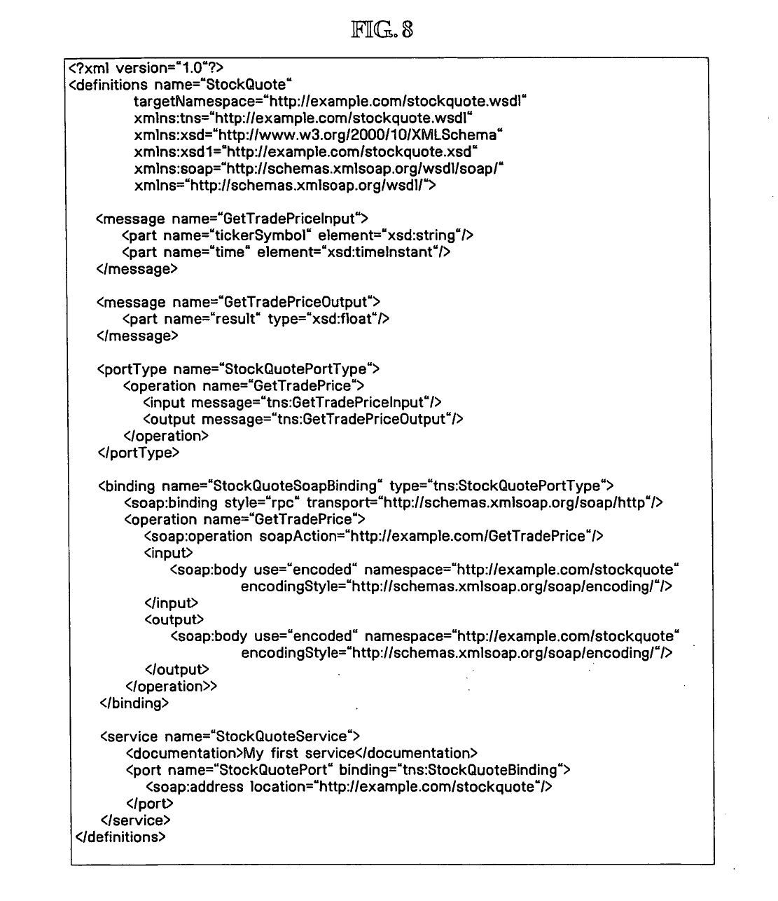

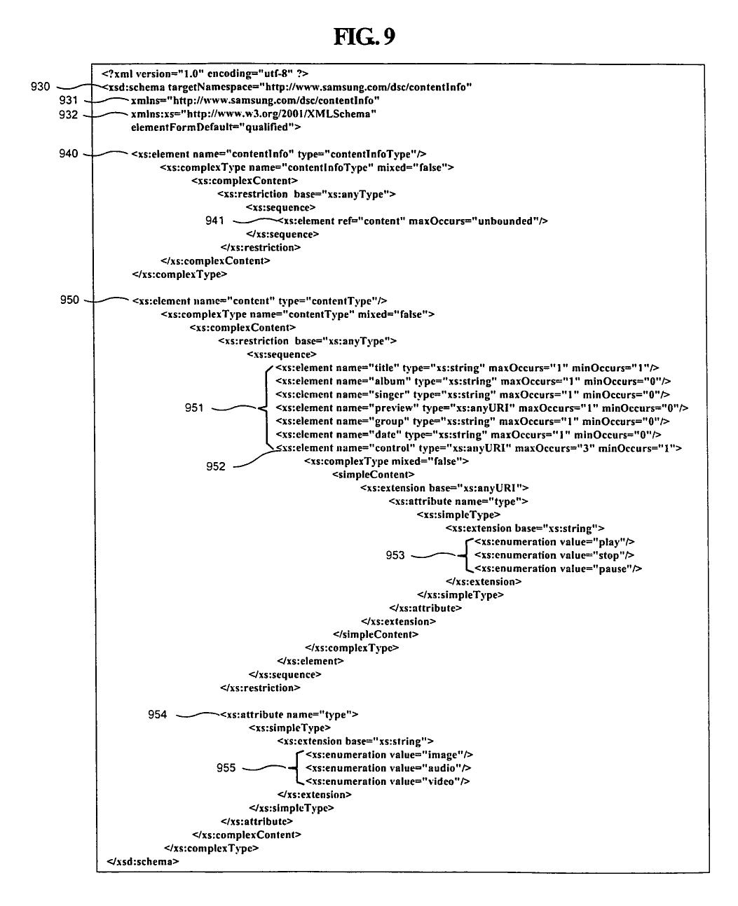

The web service content managing unit 240 generates a web service search request message according to the content information request of the content information requesting unit 250, and broadcasts the web service search request message through the TCP/IP transceiver 210. The format of the web service search request message will be described below with reference to FIG. 6. The web service content managing unit 240 receives a response message to the web service search request from the service providing device 300, and receives and analyses a markup language document (hereinafter, referred to as ML document) including detailed information about the contents. The ML document includes an XML (extensible Markup Language) document, an HTML (HyperText Markup Language) document, an SGML (Standard Generalized Markup Language) document, and various files syntactically defining data depending on defined formats. Further, the web service contents managing unit 240 searches specified contents on the web through UDDI (Universal Discovery Description Integration), analyzes detailed information of the contents expressed by WSDL (Web Services Description Language), and provides a reconstructed ML document in accordance with the corresponding control apparatus 100. The format of the response message to the web service search request, the format of the WSDL document, and the format of the reconstructed ML document will be described below with reference to FIG. 7 to, FIG. 8 and FIG. 9, respectively.

The web service content managing unit 240 analyzes the ML document received from the service providing device 300, and separates control data and content data from the received ML document. Control data is transmitted to the control apparatus 100 through the SOAP server transceiver 230, and content data is transmitted to the control apparatus 100 through the A/V network transceiver 220. On the other hand, a web service contents managing unit 240 of an A/V gateway 200 according to another embodiment of the present invention analyzes all SOAP messages received from the TCP/IP transceiver 210 and converts them into the A/V network protocols when the control apparatus 100 does not process the SOAP message (the web service message managing unit 160 is not provided). Then, the web service content managing unit 240 can analyze the information about the contents received from the service providing device 300, reconstruct information including functions to be supported by the control apparatus 100, and provide the reconstructed information to the control apparatus 100.

The A/V network transceiver 220 transmits the content stream, and the SOAP server transceiver 230 transmits control data separated by the web service contents managing unit 240 to the control apparatus 100 and receives control data from the control apparatus 100.

FIG. 6 is a diagram showing an example of a service search request message in a web service technique. This example relates to a probe message which is generated by the control apparatus 100 or the A/V gateway 200 in order to search a printer to be then broadcasted.

An action tag 610 represents that the message is a probe message, and a Types tag 620 defines such that only a target service implementing Print Basic responses to the message. A Scope tag 630 defines the response to the target service to ‘Engineering Department’.

FIG. 7 is a diagram showing an example of a response message to a service search request message in a web service technique. This example relates to the response message to the probe message for the printer search shown in FIG. 6.

An Action tag 710 represents that the message is the response message to the probe message (ProbeMatch). A RelatesTo tag 720 represents that the message is the response message to the printer search message shown in FIG. 6. A To tag 730 indicates that the response message is transmitted to the source IP address and port of the transmission header of the probe message. An Address tag 740 includes a stable and unique identifier relative to a predetermined target service over the network interface, address, and IPv4/6. In this case, the value is the URI (Uniform Resource Identifier) having a UUID (Universal Unique IDentifier) schema. A Types tag 750 lists the types to be implemented by the target service, for example, Print Basic in this example.

FIG. 8 is a diagram showing an example of a WSDL message including detailed information of a service. This example describes that a request of GetTradePrices SOAP 1.1 is transmitted to a StockQuote service through SOAP 1.1 HTTP binding.

The request gets a string of characters of stock quote symbols and returns an array of stock quotes recorded by an application which defines a TimePeriod structure including start time and end time during a period between the start time and the end time. An RPC (Remote Procedure Call) signature corresponding to this service has tickerSymbol and timePeriod as parameters and frequency as output parameters, and returns an array of real number.

FIG. 9 is a diagram showing an example of details of a file which defines the grammar structure for converting the WSDL file shown in FIG. 8 into an XML file to be supported by the control apparatus 100.

In an xsd:schema tag 930, a parameter xmlns 931 represents a position where the file is disposed, and a parameter xmlns:xs 932 represents a position where a file defining an XML specification language format is disposed.

In an Xs:element tag 940, a parameter ‘name’ is assigned to ContentInfo, and a parameter ‘type’ is assigned to ContentInfoType. In an Xs:element tag 941, the number of occurrence of a parameter ‘content’, that is, maxOccurs, is defined as ‘unbounded’. Here, the number of occurrence of the parameter ‘content’ can be the number of contents possessed by the service providing device 300, and thus the maximum is not limited. When limiting the number of contents which are transferred to the A/V gateway 200 by one service providing device 300, the parameter maxOccurs may be set to the number to be limited.

A parameter ‘name’ of an Xs:element tag 950 is assigned to ‘Content’, and a parameter ‘type’ is assigned to ‘ContentType’. Further, a tag called Content has elements such as title, album, singer, preview, group, date, and control as low-level elements 951.

Here, maxOccurs represents the maximum expression times, minOccurs represents the minimum expression times. For example, when maxOccurs is “1” and minOccurs is “1”, the element is unconditionally displayed only once. Further, when maxOccurs is “1” and minOccurs is “0”, the element may be displayed once or may be not displayed.

As a low-level element 953 of a control tag 952, one of three types of play, stop, and pause is provided. In the Control tag 952, maxOccurs is “3” and minOccurs is “1”. From this example, it can be understood that three of play, stop, and pause are displayed to the maximum and one of them is displayed to the minimum.

An xs:attribute tag 954, which represents the attribute of the xs:element tag 950 having the name ‘content’, has the name ‘type’, and the type is divided into three categories 955 of image, audio, and video.

The individual components shown in FIG. 4 and FIG. 5 can be implemented by software components or hardware components such as FPGA (Field-Programmable Gate Array) or ASIC (Application-Specific Integrated Circuit). However, the components are not limited to software or hardware. The components can be configured in an addressable storage medium or may be configured to execute one or more processors. For example, the components include software, object-oriented software, elements such as classes and tasks, processes, functions, properties, procedures, subroutines, segments of program codes, drivers, firmware, micro-codes, circuits, data, databases, data structures, tables, arrays, and variables. The components can be subdivided into smaller components or a plurality of components may be incorporated into one component.

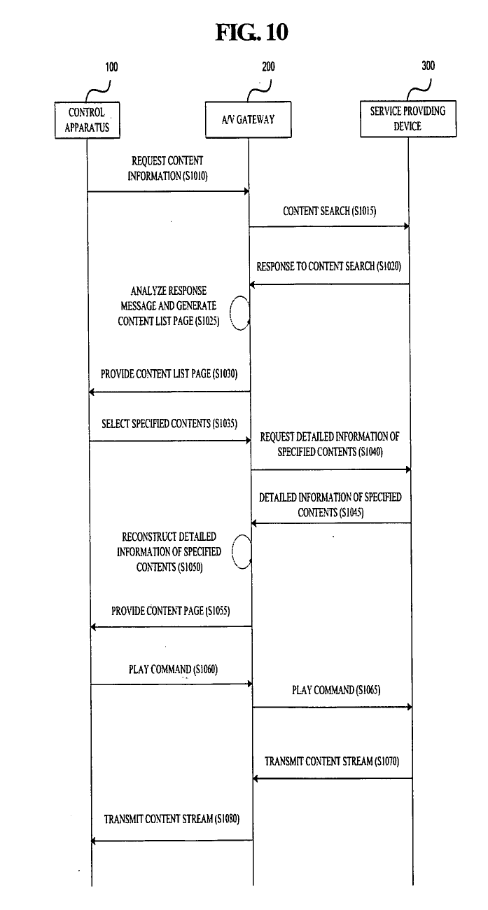

FIG. 10 is a flow chart showing an overall operation of a method of providing a content service according to an embodiment of the present invention. As shown in FIG. 10, the content service is provided between the control apparatus 100 and the service providing device 300, via the A/V gateway 200.

The control apparatus 100 receives the information about the contents to be provided by the web service, such as the name and kind of the contents, from the user through the web browser 120, and requests the A/V gateway 200 for the information about the contents at operation S1010. The A/V gateway 200 generates and broadcasts the web service search message including the information about the contents to be searched received from the control apparatus 100 so as to search a desired content service of the user at operation S1015. The format of the web service search request message is as described above with reference to FIG. 6.

The service providing device 300, which provides the content service to be searched by the A/V gateway 200, generates the response message including information indicating that it is a device providing the corresponding content service and transmits the generated response message to the A/V gateway at operation S1020. The format of the response message to the web service search request is as described above with reference to FIG. 7. The A/V gateway 200 receives the response message to the web service search request message, analyzes the response message in the XML format, and generates the content list page to be provided to the control apparatus 100 at operation S1025. One or more response messages to the web service search request message can be generated. Accordingly, the A/V gateway 200 can analyze the individual response messages, extract only required information, and generate the content list page to be provided to the control apparatus 100.

If the A/V gateway 200 provides the content list page to the control apparatus 100 at operation S1030, the control apparatus 100 cause the user to select the specified contents of the content list page. If the user selects the specified contents of the contents list page, the control apparatus 100 transfers the selection of the specified contents to the A/V gateway 200 at operation S1035, and the A/V gateway 200 generates and transmits the message requesting the detailed information of the selected contents by the service providing device 300 which transmitted the response message including the information of the selected contents by the user at operation S1040. The service providing device 300, which receives the detailed information request message, generates the message including the detailed information of the selected contents and transmits the generated message to the A/V gateway 200 at operation S1045. The format of the message including the detailed information about the contents is as described above with reference to FIG. 8.

The A/V gateway 200 analyzes the message including the detailed information about the specified contents received from the service providing device 300, reconstructs the message into the information which can be provided to the control apparatus 100 at operation S1050, and provides the page including the reconstructed information of the contents to the control apparatus 100 at operation S1055. The control apparatus 100 can receive the control command relative to the contents from the user by use of the content information page provided from the A/V gateway 200. For example, if a play command is received at operation S1060, the play command is transferred to the A/V gateway 200 through the content information page at operation S1060. Then, the A/V gateway 200 converts the play command into the control message, which is converted by the RPC of the web service, and transmits the converted control message to the service providing device at operation S1065. The service providing device 300, which receives the play command control message, transmits the content stream to be played to the A/V gateway 200 at operation S1070, and the A/V gateway 200 transmits the received content stream to the control apparatus 100 through the 1394 data link hierarchy at operation S1080. The control apparatus 100 decodes the content stream received from the A/V gateway 200 by the content decoder 140, and outputs the decoded stream to the user through the content display unit 150.

According to the method and apparatus for providing content services in the A/V network of the present invention, various complex content services can be provided by applying the conventional web service techniques to the A/V network.

As previously discussed, various components of the control apparatus 100 and the A/V gateway 200, as shown in FIG. 3, FIG. 4 and FIG. 5, can be implemented in software or hardware, such as, for example, an application specific integrated circuit (ASIC) and a field-programmable gate array (FPGA). As such, it is intended that the processes described herein be broadly interpreted as being equivalently performed by software, hardware, or a combination thereof. Software modules can be written, via a variety of software languages, including C, C++, Java, Visual Basic, and many others. The various software modules may also be integrated in a single application executed on various types of wire or wireless cards, such as PCMCIA cards, PCI cards, USB card. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the components of the control apparatus 100 and the A/V gateway 200 can be implemented in a single ASIC chipset (hardware) or firmware stalled at an existing card to perform the functions as described. In addition, alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Furthermore, both the software modules can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. A control apparatus, which is provided on an audio/video (AV) network to search web services providing contents on a different network connected to the A/V network by an A/V gateway and to receive information about the contents from a device providing the web services, thereby controlling the web services using the information about the contents, comprising:
a web browser which receives a control command relative to the contents from a user;
a simple object access protocol (SOAP) client transceiver which receives a content information message including the information about the contents depending on a SOAP specification;
a web service message managing unit which generates a control command message including the control command depending on the SOAP specification, analyzes the content information message, and extracts the information about the contents to be provided to the web browser;
an A/V network transceiver which receives stream data of the contents;
a content decoder which decodes stream data; and
a content display unit which provides a visual display of decoded stream data.

2. The control apparatus according to claim 1, wherein the different network is a TCP/IP-based network.

3. The control apparatus according to claim 1, wherein the control apparatus depends on an extendible home theater (XHT) specification, and the A/V network is an IEEE 1394 network.

4. The control apparatus according to claim 1, wherein stream data of the contents is a video stream in an MPEG-2 transport stream (TS) format.

5. The control apparatus according to claim 1, wherein the content information includes at least one of positional information of the device providing the web services, meta data of the contents, and a control operation to be supported by the contents.

6. An A/V gateway which connects an A/V network to a different network, comprising:
a content information requesting unit which requests information about contents to be provided by web services on a distributed network when a predetermined condition is satisfied;
a TCP/IP transceiver which receives an ML document including the information about the contents as a response to the request from a service providing device providing the web services;
a web service content managing unit which analyzes the ML document including the information about the contents, and generates a reconstructed ML document on the basis of the analysis result;
a SOAP server transceiver which transmits the reconstructed ML document; and
an A/V network transceiver which transmits a content stream corresponding to the information about the contents.

7. The A/V gateway according to claim 6, wherein the different network is a TCP/IP-based network.

8. The A/V gateway according to claim 6, wherein the condition is based on the assumption that a request to search the web services is received from a control apparatus.

9. The A/V gateway according to claim 6, wherein the A/V network is an IEEE 1394 network.

10. The A/V gateway according to claim 6, wherein the content stream is a video stream in an MPEG-2 transport stream (TS) format.

11. The A/V gateway according to claim 6, wherein the content information includes at least one of positional information of the device providing the web services, meta data of the contents, and a control operation to be supported by the contents.

12. The A/V gateway according to claim 6, wherein the ML document is an extensible markup language (XML) document.

13. A method of providing content services using web services which provide contents on a different network connected to an A/V network by an A/V gateway, comprising:
requesting the A/V gateway for content information;
receiving a content information page corresponding to the request of the content information;
causing a user to select specified contents through the content information page and to input a control command relative to the specified contents;
transmitting the control command; and
receiving stream data of the contents depending on the control command.

14. The method according to claim 13, wherein the different network is a TCP/IP-based network.

15. The method according to claim 13, wherein the A/V network is an IEEE 1394 network.

16. The method according to claim 13, wherein the content information includes at least one of positional information of a device providing the web services, meta data of the contents, and a control operation to be supported by the contents.

17. A method of providing content services using web services which provide contents on a different network connected to an A/V network by an A/V gateway, comprising:
requesting content information to be provided by the web services on a distributed network when a predetermined condition is satisfied;
receiving an ML document including the content information as a response to the request from a service providing device providing the web services;
analyzing the ML document including the content information, and generating a reconstructed ML document on the basis of the analysis result;
transmitting the reconstructed ML document; and
transmitting a content stream corresponding to the content information.

18. The method according to claim 17, wherein the different network is a TCP/IP-based network.

19. The method according to claim 17, wherein the A/V network is an IEEE 1394 network.

20. The method according to claim 17, wherein the content information includes at least one of positional information of the service providing device, meta data of the contents, and a control operation to be supported by the contents.

21. A recording medium with a computer readable program recorded thereon for executing the method for providing content services according to claim 13.

22. A system, comprising:
a service providing device to provide web services;
an A/V gateway;
a control apparatus arranged to search web services, via an audio/video (A/V) network, and provide content on a different network, via the A/V gateway, the control apparatus comprising:
a web browser to receive a control command relative to the content from a user;
a simple object access protocol (SOAP) client transceiver to receive a content information message including information about the content depending on a SOAP specification;
a web service message managing unit to generate a control command message including the control command depending on the SOAP specification, analyze the content information message, and extract information about the content to be provided to the web browser;
an A/V network transceiver to receive stream data of the content;
a content decoder to decode stream data; and
a content display unit to provide a visual display of decoded stream data.

23. The system according to claim 22, wherein the different network is a TCP/IP-based network.

24. The system according to claim 22, wherein the control apparatus depends on an extendible home theater (XHT) specification, and the A/V network is an IEEE 1394 network.

25. The system according to claim 22, wherein stream data of the content is a video stream in an MPEG-2 transport stream (TS) format.

26. The system according to claim 22, wherein the content information includes at least one of positional information of the device providing the web services, meta data of the content, and a control operation to be supported by the content.

27. The system according to claim 22, wherein the A/V gateway which connects an A/V network to the different network, comprises:
a content information requesting unit arranged to request information about the content to be provided by web services on a distributed network when a predetermined condition is satisfied;
a TCP/IP transceiver arranged to receive an ML document including the information about the content as a response to the request from the service providing device providing the web services;
a web service content managing unit arranged to analyzes the ML document including the information about the contents, and generate a reconstructed ML document on the basis of the analysis result;
a SOAP server transceiver arranged to transmit the reconstructed ML document; and
an A/V network transceiver arranged to transmit a content stream corresponding to the information about the content.

28. The system according to claim 27, wherein the condition is based on the assumption that a request to search the web services is received from the control apparatus.
